(19) United States
(12) Patent Application Publication
(10) Pub. No.: US 2010/0104268 A1
(43) Pub. Date: Apr. 29, 2010

(54) METHOD AND APPARATUS FOR PLAYING AN OPTICAL DISC

(75) Inventors: Yang Peng, Shanghai (CN); Declan Patrick Kelly, Shanghai (CN); Dahua He, Shanghai (CN); Sheng Jin, Shanghai (CN); Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/722,202

(22) PCT Filed: Dec. 15, 2005
(86) PCT No.: PCT/IB2005/054266

§ 371 Date: Dec. 9, 2009

(30) Foreign Application Priority Data
Dec. 29, 2004 (CN) 200410082189.X

(51) Int. Cl. H04N 5/00

(52) U.S. Cl. 386/126; 386/E05.064

(57) ABSTRACT

The present invention provides a method and apparatus for playing an optical disc, and an optical disc recording apparatus. According to the method provided by the present invention, the description information of the program content and the description information of the enhancement content are first acquired, and then compared with each other; then it is judged whether the program corresponds to the enhancement content according to the result of the comparison; and finally, the program content is played independently of the enhancement content if the program content does not correspond to the enhancement content. With the present invention, the playback problem causing from the non-match of the program content and the enhancement content in an optical disc with the enhancement format resulting from the revision of the optical disc by a conventional optical disc recording apparatus that does not support the enhancement format can be avoided.

### BACKGROUND OF THE INVENTION

The present invention relates to the field of an optical storage, in particular to a method and apparatus for playing an optical disc, and further to an optical disc recording apparatus.

With the development of the optical storage technology, an optical disc can not only store a huge amount of information, but also serve as a way and a window to obtain more information, as exemplified by an optical disc having the enhancement format, such as Enhanced Digital Versatile Disc (eDVD) format and Blu-ray disc format. These formats have broken through the limitation within which a conventional optical disc formats can only support to play contents stored in an optical disc, and can further support to play an enhancement content through the enhanced function therein. For example, it can play the related contents on the internet according to the internet link information in the optical disc, so that users can have some unprecedented audiovisual experience.

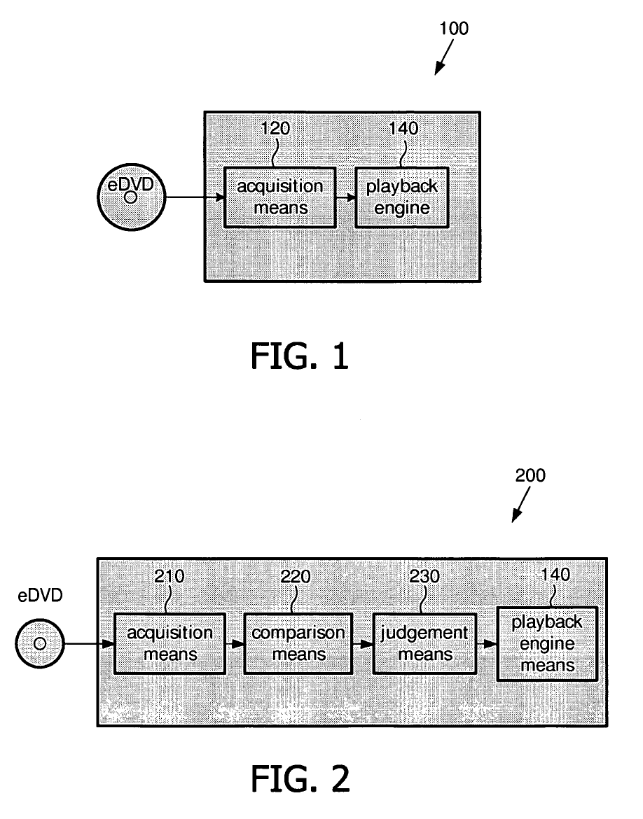

FIG. 1 is a schematic view of a conventional enhancement format optical disc playback apparatus 100. The optical disc playback apparatus 100 comprises an optical reading means 120 for reading information (e.g. a program content and a enhancement content, etc.) from an optical disc. The apparatus 100 also includes a playback engine 140 for playing the program contents and the enhancement contents according to the information read by the optical reading means 120.

The enhancement format for an optical disc has various advantages, making an optical disc, a player and a recorder, which have the enhancement format more and more widely applicable. However, there are a large number of the conventional players and recorders in the market that do not support the enhancement format, and they cannot identify and process the enhancement contents on an optical disc.

If an enhancement format optical disc recorder (e.g. eDVD recorder) is used to record an erasable, re-writable optical disc of an enhancement format (e.g. eDVD-RW) or to add contents to, or delete them from the optical disc, its program contents and corresponding enhancement contents will all be revised correspondingly. The optical disc content and the enhancement content of the optical disc can be played normally by an enhancement format player (e.g. eDVD player).

However, if a conventional optical disc recorder (e.g. a DVD recorder) is used to record an enhancement format optical disc (e.g. eDVD-RW) or add/delete its contents, then the conventional optical disc recorder can only revise the program contents (e.g. DVD menu, video contents in the video band of the DVD, etc.), but cannot revise the enhancement content, because it cannot identify the enhancement format. As a result, the optical disc program and the enhancement contents that correspond to each other before do not, or even quite different from each other now.

If the optical disc is put and played in an enhancement format player (such as an eDVD player) again, then the absurd playback effect would possibly occur, because the program contents and the enhancement contents in the optical disc may not match each other/have no any relationship between each other at all, or even an erroneous playback would occur, thus affecting users' enjoying the disc information.

Besides, when an enhancement format recorder is used to record an optical disc, the program content (including description information) will be recorded in such a way that a conventional non-enhancement format optical disc player can identify it, and the enhancement content will be recorded in the enhancement format. The way of recording has cut apart the associated relations between the program contents and the enhancement contents, and to a certain extent made aforesaid non-matched problem between the program contents and the enhancement contents in eDVDs sharply evident.

For that matter, a method and an apparatus for playing an optical disc, and, as well, an optical disc recording apparatus are needed to avoid the playback problem arising from the non-match between the program contents and the enhancement contents in eDVDs.

### OBJECT AND SUMMARY OF THE INVENTION

An object of the present invention is to provide a method and apparatus of playing an optical disc, and an optical disc recording apparatus to resolve the playback problem resulting from the revision of eDVD by a conventional recording apparatus.

According to one embodiment of the present invention, a method of playing an optical disc is provided, and the contents on said optical disc include a program content and an enhancement content, the method comprising the steps of: acquiring the description information of said program content and the description information of said enhancement content; comparing the description information of said program content with the description information of said enhancement content, judging whether said program corresponds to said enhancement content on the basis of the result of said comparison; and playing said program content independently of said enhancement content if said program content does not correspond to said enhancement content. Said description information may include some information about the number of titles of the program content, the time for playing the titles, information storage addresses and the playback relations (such as time or position relations, etc) with other contents in said optical disc.

According to another embodiment of the present invention, an apparatus of playing an optical disc is also provided, and the contents on said optical disc include a program content and an enhancement content, the apparatus comprising: an acquisition means for acquiring the description information of said program content and the description information of said enhancement content; a comparison means for comparing the description information of said program content with the description information of said enhancement content; a judgement means for judging whether said program corresponds to said enhancement content on the basis of the result of said comparison; and a playback engine means for playing the contents on said optical disc, and playing said program content independently of said enhancement content if said program content does not correspond to said enhancement content.

According to still another embodiment of the present invention, an optical disc recording apparatus is provided, which comprises: a recording means for recording a program content and an enhancement content on an optical disc; an acquisition means for acquiring the description information of said program content and the description information of said enhancement content, wherein said recording means records the description information acquired by the acquisition means on said optical disc in an enhancement format to judge whether said program content corresponds to said enhancement content.

The method and apparatus of playing an optical disc provided by the present invention can prevent the playback problem resulting from the revision of an optical disc by a conventional optical disc recorder that does not support the enhancement format through judgement of whether the content to be played and the enhancement content correspond to each other, and determination of whether the enhancement content is to be played on the basis of the result of the judgement.

When recording programs, the optical disc recording apparatus provided by the present invention also records the description information of this program on the optical disc in an enhancement format; hence the description information will not be revised by a conventional recorder. During playing the optical disc, it can be judged whether said program corresponds to said enhancement content through comparison between the program description information stored in the enhancement format and the program of said optical disc to see whether they are consistent or not, thereby it is accordingly judged whether to play the enhancement content, so as to prevent the playback problem resulting from the revision of an optical disc by a conventional optical disc recorder

The other objects and achievements of the present invention will be made more evident, and the present invention be more comprehensively understandable by virtue of the following description and claims with reference to the appended drawings.

### DETAILED DESCRIPTION OF THE DRAWINGS

The present invention will be explained in detail by way of examples and with reference to the drawings, in which:

FIG. 1 is a schematic view of a conventional optical disc playback apparatus;

FIG. 2 is a block diagram of the optical disc playback apparatus according to one embodiment of the present invention;

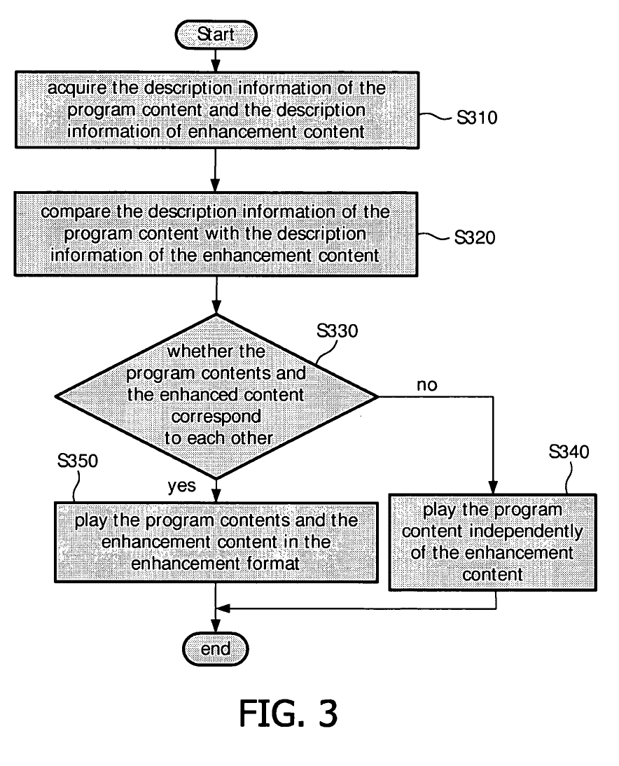

FIG. 3 is a flow chart of the method for playing optical disc according to one embodiment of the present invention; and

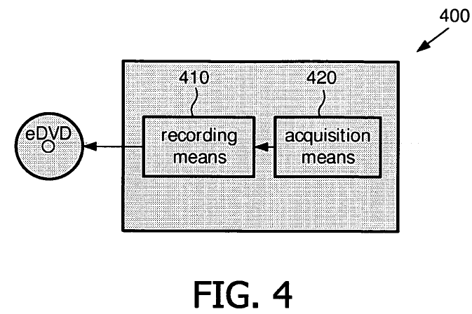

FIG. 4 is a block diagram of the optical disc recording apparatus according to one embodiment of the present invention.

The same reference numbers in the Figs. indicate the similar or identical features and functions.

### DETAILED DESCRIPTION OF THE INVENTION

The conception of the present invention follows: the description information of the program content on an optical disc is compared with the description information of the enhancement content to determine whether they correspond to each other, and it is judged whether the program content corresponds to the enhancement content, so as to determine whether to play the enhancement content. The present invention is described with the examples of the eDVD-RW format (the enhancement content) and DVD format (the conventional disc format that does not support the enhancement content).

The description information of the DVD video program include the number of titles of the contents and playing time of the contents, which are recorded on the optical disc in the ECMAScript (European Computer Manufacturers Association Script) code. A conventional DVD recorder may revise the DVD video content on an erasable, rewritable optical disc (e.g. delete or add, etc), but cannot identify and revise the description information of the DVD video program content stored in the eDVD format because it does not support the enhanced function, and, as a result, the description information of the program stored in the eDVD format is not consistent with the added/deleted DVD video program content.

According to the present invention, it is first judged according to the description information of said program content and said enhancement content whether the program content and the enhancement content are consistent with each other, so as to determine whether to play the enhancement content in order to avoid the playback problem arising from the non-match for the program and the enhancement content.

FIG. 2 is a schematic diagram of the optical disc playback apparatus 200 according to one embodiment of the present invention. Apparatus 200 is used for playing the optical disc having the enhancement format (such as eDVD-RW), and the information on the disc contains a program content and an enhancement content.

Apparatus 200 includes an acquisition means 210 for acquiring, from an optical disc, the description information of the program content and the description information of the enhancement content. The description information of the enhancement content may be its link information on the Internet, playback control information and the description of its playback relationship with other program content. The description information of the program content may be the information about the number of titles of the program, the time for playing the program, program storage address and the playback relations (such as time or position relations, etc) between the program and other program (e.g. enhancement contents).

Apparatus 200 further includes a comparison means 220 for comparing the acquired description information of the program and the description information of the enhancement content. The description information of the enhancement content and the description information of the program content are compared to see whether there are any corresponding and consistent information content. For example, comparison is made to see whether the description information of the enhancement content contains the description of the number of titles of the corresponding program content, play starting time, or the playing corresponding relation with the program, etc.

Apparatus 200 also includes a judgement means 230 for judging whether the program content and the enhancement content correspond to each other on the basis of the result of comparison made by the comparison means 220. If the description information of the enhancement content and the description information of the program content contain the corresponding and consistent information content, for example, information about the associated relationship between the enhancement content and the program content, then the program content corresponds to the enhancement content, otherwise not.

Apparatus 200 also includes a playback engine means 240 for playing the contents on said optical disc, and playing said program content independently of said enhancement content if said program content does not correspond to said enhancement content. Playback engine 240 will play the program content and the enhancement content according to the judging by the judgement means 230. If the program content corresponds to the enhancement content, the program content and the enhancement content will be played in the conventional manner. If they do not, any synchronized playback of the program content and the enhancement content would make the playback effect very absurd, or make the playback quite impossible, thus it only plays the program content, not the enhancement content, that is, plays the program content independently of the enhancement content.

For example, an eDVD-RW contains the DVD video program and the enhancement content, such as the ENAV (enhanced navigation) content, then if the description information of the DVD video program does not correspond to the description information of the enhancement content, only the DVD video program is played, not the ENAV content. What is shown to users is the DVD video content as the conventional DVD playback apparatus plays a conventional DVD video program. Although apparatus 200 plays an optical disc in the enhancement format, it only plays the program content, which prevents the playback of the non-matched enhancement content, thereby avoid any playback error caused likely.

FIG. 3 is a flow chart of the method for playing an optical disc according to one embodiment of the present invention. This embodiment is based on the eDVD-RW with the enhancement format, the eDVD-RW contains the DVD video program and the enhancement contents.

First, the description information of the program content and the description information of the enhancement content are acquired from an optical disc (step S310). The description information of the program content may contain the total number of the titles of the program, that is, the number of all the program titles, the time for playing the program titles, such as the time for playing each title and the time for playing all the titles, etc. The description information of the enhancement content may contain the link information of the enhancement content on the Internet and playback control information, etc.

After that, the description information of the program is compared with the description information of the enhancement content on the basis of the acquired description information (step S320), that is, comparing the description information of the enhancement content with that of the program content to see whether there are some corresponding and consistent information contents. For example, to see whether the program content is consistent with the enhancement content in the total number of the titles and the time of the titles.

Following that, it is judged according to the result of said comparison whether the program content and the enhancement content correspond to each other (step S330). If there are some corresponding and consistent information contents in the description information of the enhancement content and that of the program content (such as, the total number of titles and the time for playing the titles), then the program content and the enhancement content correspond to each other, otherwise not.

Finally, if the program content and the enhancement content do not correspond to each other according to the result of said judgement, then only the program content, not the enhancement content, is played. That is, the program content of an optical disc is played independently of the enhancement content (step S340). If the program to be played and the enhancement content correspond to each other, thus the condition in which the program to be played and the enhancement content are not matched each other would not occur, and the playback error would not be caused, then, the content to be played and the enhancement content are played selectively. If the program content corresponds to the enhancement content, said program and the enhancement content are played in the enhancement format to realize the enhanced playback effect (step S350).

In step S320, if the time of titles in the description information is compared, then judgement of the time for playing the titles of the program is sequentially made. As long as one of the time for playing titles is not consistent with the time for playing the title of the program described in the description information of the enhancement content, it may be judged in step S330 that the program content does not correspond to the enhancement content, that is, it has revised by an optical disc recorder that does not support the enhancement format, thereby causing the enhancement content and the program content not to correspond to each other.

In step S320, judgement may also be sequentially made for the time of all the titles on a disc to determine the program titles that have been revised by an non-enhancement format recorder and the program titles that have not revised by an non-enhancement format recorder. Then, as to the revised titles, only the program content is played, and as to the unrevised titles, the program content and the enhancement content may be played according to the corresponding relations, thereby more enhanced characteristics is retained.

It should be noting that in this embodiment if an optical disc is revised by a conventional recorder that does not support the enhancement format, it is almost impossible for the total time to play the titles obtained from the optical disc to be same as that in the description information of the enhancement content, but there is very small possibility that they are the same.

Of course, if it is only judged whether the optical disc with the enhancement format is revised by a conventional optical disc recorder that does not support the enhancement format, and determined whether to selectively play the content to be played and the enhancement content, then some other simple methods may be used. For example, some identification file or certain digital signature of some particular sector (also referred to as a description information on an optical disc) are stored in the optical disc, in turn these files are first retrieved before playing the optical disc, and if the files are not found or the retrieved files are not those that meet the requirements, then it may be determined that the optical disc has been revised by a conventional recorder that does not support the enhancement format. Or, a private file corresponding to a certain brand or a mute audio file, etc stored in the enhancement format would normally be deleted by a recorder of another brand; thereby it is judged whether the optical disc has been revised or not.

FIG. 4 is a schematic view of an optical disc recording apparatus 400 according to one embodiment of the present invention. Apparatus 400 includes a recording means 410 for recording the program content and the enhancement content on an optical disc. Apparatus 400 also includes an acquisition means 420 for acquiring the description information of the program content and that of the enhancement content, wherein said recording means 410 records the description information on said optical disc in the enhancement format, so as to judge whether said program content corresponds to said enhancement content.

As for e-DVD, means 410 can record the description information on the optical disc in the form of ECMAScript code; as for BD, it may be recorded on a disc in the JAVA language. Said description information contains at least one of the following: the number of the titles of the program content, the time for playing the program titles, VIDEO_RM directory file, and the files in the data zone on the optical disc or the data signature of the sector.

The enhanced-format disc recording apparatus provided according to the present invention can describe the relationship between the program content and the enhancement content on an optical disc in the enhancement format; hence, it can be determined to synchronically play both the program content and the enhancement content corresponding to each other. As to the program content and the enhancement content not corresponding to each other, only the former, not the latter, is played.

As for an optical disc having the enhancement format, the result obtained through revising it by a conventional recorder that does not support the enhancement format is different from that by a recorder that supports the enhancement format. The present invention can use this characteristic to judge whether the program content corresponds to the enhancement content, and then to determine the content to be played; thereby the playback problem has been resolved resulting from the revision by a conventional recorder that does not support the enhancement format. The present invention applies not only to the eDVD format, but also to any optical disc format that supports the enhancement content. For example, it also applies to the next-generation erasable, re-writable Blu-ray disc format and the high definition optical disc format.

The present invention has been described above in combination with the embodiments. It is evident that those skilled in the art can obviously make many substitutions, modifications and variations according to the description above. So, all substitutions, modifications and variations falling within the spirit and scope of the following claims should be included in the present invention.

1. A method for playing an optical disc, the content in said optical disc including a program content and an enhancement content, comprising the steps of:
(a) acquiring the description information of said program content and the description information of said enhancement content;
(b) comparing the description information of said program content with the description information of said enhancement content;
(c) judging whether said program corresponds to said enhancement content on the basis of the result of said comparison; and
(d) playing said program content independently of said enhancement content if said program content does not correspond to said enhancement content.

2. The method according to claim 1, wherein the description information of said program content includes the description of the playing relationships between the program content and any other playable content.

3. The method according to claim 1 or claim 2, wherein the description information of said enhancement content includes the description of the playing relationships between the enhancement content and any other playable content.

4. The method according to claim 1 or claim 2, wherein the description information of said program includes the title information of said program.

5. The method according to claim 4, wherein said title information includes at least one of the followings: total number of the titles, time for playing a title, or total time for playing the titles.

6. An apparatus for playing an optical disc, the content on said optical disc including a program content and an enhancement content, comprising:
an acquisition means for acquiring the description information of said program content and the description information of said enhancement content;
a comparison means for comparing the description information of said program content and the description information of said enhancement content;
a judgement means for judging whether said program corresponds to said enhancement content on the basis of the result of said comparison; and
a playback engine means for playing said optical disc according to the result of said judgement, and playing said program content independently of said enhancement content if said program content does not correspond to said enhancement content.

7. The apparatus according claim 6, wherein the description information of said program content includes the description of the playing relationships between the program content and other playable content.

8. The apparatus according claim 6 or claim 7, wherein the description information of said enhancement content includes the description of the playing relationships between the enhancement content and other playable content.

9. The apparatus according claim 6 or claim 7, wherein the description information of said program includes the title information of said program.

10. The apparatus according claim 9, wherein said title information includes at least one of the followings: total number of the titles, time for playing a title, or total time for playing the titles.

11. An optical disc recording apparatus, comprising:
a recording means for recording a program content and an enhancement content in an optical disc; and
an acquisition means for acquiring the description information of said program content and the description information of said enhancement content,
wherein said recording means records the description information acquired by the acquisition means in said optical disc in the enhancement format to judge whether said program content corresponds to said enhancement content.

12. The apparatus according claim 11, wherein the description information of said program content includes the description of the playing relationships between the program content and other playable content.

13. The apparatus according claim 11 or claim 12, wherein the description information of said enhancement content includes the description of the playing relationships between the enhancement content and other playable content.

14. The apparatus according claim 11 or claim 12, wherein the description information of said program includes the title information of said program.

15. The apparatus according claim 14, wherein said title information includes at least one of the followings: total number of the titles, time for playing a title, or total time for playing titles.
